(19) United States
(12) Patent Application Publication
(10) Pub. No.: US 2007/0182403 A1
(43) Pub. Date: Aug. 9, 2007

(54) Device for monitoring the position and displacement of a brake pedal

(76) Inventors: Holger von Hayn, Bad Vilbel (DE); Jurgen Schonlau, Walluf (DE); Manfred Ruffer, Sulzbach (DE); Wolfgang Ritter, Oberursel/Ts. (DE); Milian Klimes, Zornheim (DE); Torsten Queisser, Frankfurt (DE); Heinrich Kreh, Florstadt (DE); Thomas Voigtmann, Friedrichsdorf-Koppern (DE)

Correspondence Address: CONTINENTAL TEVES, INC., ONE CONTINENTAL DRIVE, AUBURN HILLLS, MI, 48326-1581, US

(21) Appl. No.: 10/552,407

(22) PCT Filed: Apr. 7, 2004
(86) PCT No.: PCT/EP04/50461

§ 371 Date: Dec. 14, 2006

(30) Foreign Application Priority Data
Apr. 7, 2003 (DE) 103 16 035.3
May 21, 2003 (DE) 103 22 688.5
Dec. 9, 2003 (DE) 103 57 709.2
Feb. 3, 2004 (DE) 10 2004 005 405.3
Mar. 24, 2004 (DE) 10 2004 014 808.2

(51) Int. Cl. G01B 7/14

(52) U.S. Cl. 324/207.24; 324/207.2

(57) ABSTRACT

Disclosed is a device for monitoring the position and movement of a brake pedal, including a master cylinder 1; 102 with an integrated position generator for monitoring the position of a piston 2; 105 within a housing 6; 103 for use in a controlled brake system for motor vehicles, in particular with driving dynamics control, and the position generator includes a magnet 35; 150 as a signal transmitter which transmits a magnetic field in the direction of a sensor element 36; 151 being stationary on the housing 6; 103, and is connectable to an electronic control unit. To monitor a push rod piston even during a driving dynamics control operation, it is disclosed that the magnet 35; 150 is arranged between two pistons 2, 3; 105, 106 and is displaceable in relation to at least one of the pistons 2, 3; 105, 106. This renders possible a relative displaceability of the magnet 35; 150 in relation to a stationary piston 3; 106 and a proportional displaceability of the magnet 35; 150 in relation to an actuated piston 2; 105 when the piston 3; 106 cannot be displaced in relation to the housing 6; 103 as a result of closed separating valves in a braking operation during a driving dynamics control operation.

### BACKGROUND OF THE INVENTION

Devices for monitoring positions and displacements of a brake pedal are principally known in the art.

WO 02/43996 A1 discloses a pedal-operable master cylinder which is equipped with an integrated position generator in order to allow monitoring the position of a displaceable first piston within a cylinder housing for use in a controlled brake system for motor vehicles, wherein the piston includes a magnet as a signal transmitter which transmits a magnetic field in the direction of a sensor element being stationary on the housing.

The sensor assembly is designed for driver-initiated braking maneuvers in the normal operation, and the piston being monitored covers a defined actuating travel. The magnet is acted upon by means of a spring element which is supported with one end on a housing bottom, and hence is supported on a stationary component relative to the push rod piston.

In modern driving dynamics control systems, a driving dynamics control action regularly causes automatic interruption of a hydraulic connection between master cylinder and wheel brakes which is normally constantly opened, with the result that the piston in braking maneuvers during the driving dynamics control action (ESP control intervention) is quasi undisplaceable in relation to the housing due to closed separating valves. One cause is that pressure fluid cannot be conducted in the direction of the wheel brakes. The ESP intervention takes place irrespective of the driver, and the rudimentary piston travel is not sufficient to displace the magnet into the range of the sensor element. Also, the ESP action cannot be interrupted by the driver so that only limited deceleration is possible. Further, an actuating signal cannot be generated, and e.g. stop light signaling is impossible. The traffic in the rear is informed about the braking request of the driver only after the driving dynamics control action is completed.

It would be possible to use a separate stop light switch sensing brake pedal application for the above-mentioned purpose. However, the number of components and, in particular, the assembly of stop light switches in the leg room of a motor vehicle is considered complicated and costly.

### SUMMARY OF THE INVENTION

In view of the above, the objective is to offer a solution to the problems in order to enable reliable monitoring of a piston also during a driving dynamics control action.

To solve this object, proposals have been made to arrange the magnet between two pistons and to render it displaceable in relation to at least one of the pistons. As a result, the piston along with is assembly components is quasi floatingly suspended. In further specifying the invention, a spring means is provided by which the magnet is retained between the pistons and is arranged so as to be displaceable in relation to at least one of the pistons. Thus, the magnet is quasi elastically compressed between two pistons rather than being coupled stationarily to the piston like a slave by means of a spring between the housing and the piston. This elasticity of the magnet's compression will therefore permit an improved signal generation that is adapted to different operating conditions along with a relative displaceability of the magnet.

It is expedient to provide the magnet together with associated components such as the spring as a subassembly which is pre-assembled and, hence, is easier to be fitted into the master cylinder housing in the final assembly.

In another embodiment of the invention, the spring means comprise a resetting spring supported on the first piston and an additional spring means supported on the magnet, with the additional spring means showing a higher degree of resiliency than the resetting spring. Depending on whether the movement and the actuation of the magnet shall take place in series or in parallel to the movements of the two pistons, the additional spring means is supported on the second piston or on a component that is movable by the displacement of the first piston. The resiliencies permit a defined displacement of the magnet depending on the piston displacement.

In a favorable embodiment of the invention, the sensor element comprises a Hall element which renders possible not only a switch function but principally even a linear detection of the position of the piston, if desired.

The second piston can include a means for guiding the magnet, thereby allowing a precise signal generation. Preferably, the piston has a peg-shaped piston portion which is used to guide the magnet and can be shaped on the piston during its manufacture without greater effort.

The utilization of the magnet's material is further improved when a support member made of a non-magnetic material is arranged between the magnet and the piston portion, and when the magnet is interposed in an axial direction between plates made of an iron material, so-called pole plates.

The plates in this arrangement permit bundling the magnetic field so that the wall of the housing can be of a sufficient thickness in order to withstand great compression stress. In addition, the effect of force on the magnet is rendered more homogeneous by distributing it onto a larger surface, and the magnet is kept together by the plates in a case of rupture.

For example, the magnet may have an annular design, whereby the sensor element can theoretically be arranged in any desired position at the periphery of the housing.

It is also possible within the spirits of the invention not to design the magnet annularly, while it is necessary to correctly position and guide the magnet on the piston with respect to the sensor element.

Preferably, the support member is of a one-part design and has a substantially cylindrical configuration, and it has a bead for the axial abutment of the magnet and a stop is provided on the piston portion for limiting the relative displacement travel of the support member with respect to the piston. The additional spring means is supported on the piston in a favorable embodiment. This renders it possible to form subassemblies at the second piston including the magnet.

The overall length available is efficiently used because the resetting spring is arranged at least partly within a bowl-shaped wall of the piston and is centrally penetrated by a peg with a stop on which a sleeve is fixed in position in such a fashion that, upon displacement of the piston during actuation, the means for guiding the magnet plunges axially and telescopically into the interior of the sleeve.

Ease of manufacture of the support member is achieved in that the support member, according to a favorable improvement of the invention, includes a first cylindrical portion and a second cylindrical portion, and the magnet is arranged on the second cylindrical portion of the support member, while the support member with its second cylindrical portion is guided on the piston portion of the second piston. For guiding purposes and as a rotation-prevention mechanism, the support member preferably has two projections pointing radially inwards and engaging into recesses of the second piston portion. This renders precise signal generation possible.

Another subassembly is formed in a simpler fashion because the support member has a multipart design and includes a spring sleeve and a magnet sleeve, and the spring sleeve includes projections pointing radially outwards and being arranged between projections of the magnet sleeve pointing radially inwards for the connection with the magnet sleeve, with said projections, for guiding purposes and as a rotation-prevention mechanism of the support member on the piston portion, engaging into recesses of the second piston portion, and with the magnet being arranged on the magnet sleeve.

In an embodiment of the invention, the resetting spring and the additional spring means are joined in an elastically biased manner by means of a (spring) cage in such a fashion that displacement of the piston during actuation allows compression of the resetting spring and expansion of the additional spring means in order to render possible a proportional displacement of the magnet in relation to the piston. Integrating the magnet and the spring elements within the subassembly of the spring cage enables an efficient assembly because e.g. the correct positioning of the magnet when fitted on the subassembly can be checked.

In another favorable embodiment of the invention, the spring cage includes a sleeve for the mounting support of the magnet and a spring accommodation which is arranged thereon in a way displaceable within limits and is acted upon by resetting spring and spring means. When the piston is displaced during actuation, the spring accommodation is movable into abutment on the second piston in such a fashion that sleeve and magnet are displaced in the actuating direction in relation to the second piston by way of expansion of the spring means. The expansion of the spring means is enabled because the captivation of the sleeve at a push rod is reduced by the piston displacement and by the compression of the resetting spring.

In an advantageous improvement of the invention, the cage has a first sleeve and a second sleeve for preloading the resetting spring, and a support member, wherein upon displacement of the piston during actuation the magnet is displaced in relation to the piston in the actuating direction (A) by way of expansion of the additional spring means. The expansion of the spring means is enabled because the captivation of the second sleeve at a push rod is reduced by the piston displacement and by the compression of the resetting spring.

According to another favorable embodiment, the magnet is guided and arranged on the second sleeve, and the support member has projections pointing radially outwards and being guided in recesses of the second sleeve. Preferably, the magnet is interposed in an axial direction between plates made of an iron material which include radially inwards pointing projections and webs that are guided in the recesses of the second sleeve. The second sleeve favorably has a step on an inside surface, and the additional spring means is arranged between the step and the plate in a biased manner. This allows a precise signal generation.

An additional spring means is interposed in a biased manner between the first sleeve and the support member in another favorable embodiment of the invention.

In favorable improvements of the invention, the sensor element can be simply positioned because it is arranged in an accommodation that can be fixed in a defined position on the housing. The advantages are especially achieved when the accommodation can be adjusted in the actuating direction of a piston and in relation to the housing and can be fixed in a defined position.

Advantageously, exchangeability is given when the sensor element along with rigid conductor elements is received in the accommodation in a form-locking manner, and when an electric connecting line can be slipped into a plug device of the accommodation.

A defined positioning is rendered possible, when the housing has a stop for the accommodation, and when spacer elements accurately tolerated in their distance are arranged between stop and accommodation for providing a defined distance.

Positioning of the components to be mounted peripherally, which is neutral with regard to mounting space, is rendered possible when the accommodation is arranged between two pressure fluid supply bores in the housing. According to another type of construction with sensing of a secondary piston, the accommodation is provided at a housing end.

### BRIEF DESCRIPTION OF THE DRAWING

The drawing shows a cross-sectional view of favorable embodiments of the invention, which are described in detail in the following.

### DETAILED DESCRIPTION OF THE DRAWING

In addition to wheel brakes, a vehicle brake system comprises a hydraulic unit connected thereto by means of tubes or hose pipes and including normally open or closes valves (inlet valves, outlet valves, separating and switch-over valves, with the latter serving for a change in the aspiration line of the pump for the purpose of pressure generation in at least one wheel brake) and an integrated return pump or pressure increase pump and a pedal-operable master cylinder 1, with a first and a second piston 2, 3 for first and second pressure chambers 4, 5, with the pistons 2, 3 being displaceably arranged within a housing 6 for the purpose of supplying pressure fluid to wheel brakes grouped in pairs in brake circuits. It is self-explanatory that connected upstream of the master cylinder 1 can be a brake booster for generating a servo force, event if this task can principally be performed by another pressure increase source such as the pump.

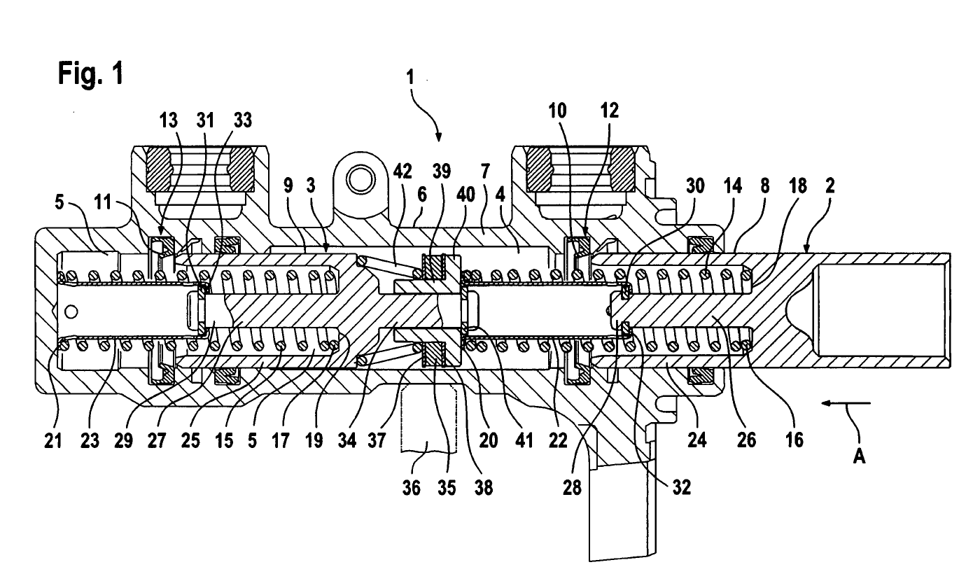

The master cylinder 1 of FIGS. 1 to 5 is of the so-called plunger type with stationary sealing cups 12, 13 arranged in a housing wall 7 and abutting on a piston wall 8, 9 with a sealing lip 10, 11 for sealing the pressure chambers 4, 5. Fluid can flow over the sealing lips 10, 11 in the direction of the wheel brake if a pressure gradient is adjusted between the pressure fluid supply reservoir and the wheel brake (not shown). For the non-actuated operating condition, a pressure-compensating connection is further established between the two pressure chambers 4, 5 so that a general pressure balance exists also between the two brake circuits for this non-actuated operating condition.

Associated with each of the pistons 2, 3 is a resetting spring 14, 15 which is supported with one end 16, 17 on a piston bottom 18, 19, while with its other end it is supported indirectly on the housing 6 by way of a collar 20, 21 of a sleeve 22, 23. In the event of piston displacement in an actuating direction A, the resetting spring 14, 15 is compressed, and it is expanded for piston resetting purposes.

The embodiment of FIG. 1 will be dealt with in detail in the following. Starting from the piston bottom 18, 19, the pistons 2, 3 have a bowl-shaped wall 24, 25 within which the resetting spring 14, 15 is arranged at least in part. Extending centrally through the wall 24, 25 is a centric peg 26, 27 which ends before its axial exit from the wall 24, 25. This end 28, 29 is provided with a stop 30, 31 for the sleeve 22, 23 that cooperates with a collar 32, 33 in such a fashion that the sleeve 22, 23 can be telescoped within limits in relation to the peg 26, 27. More precisely, the sleeve 22, 23 with resetting spring 14, 15 is urged into the interior of the piston upon actuation. As can be seen, the stop 30, 31 is preferably an annular washer which is riveted, in particular wobble-riveted, to the peg 26, 27. The other end of sleeve 22, 23 has the plate-type collar 20, 21 for abutment of the resetting spring 14, 15.

The second piston 3 additionally has a peg-shaped piston portion 34 that is opposed to the peg 27 and used as a means for guiding a permanent magnet 35.

Magnet 35 serves as a signal transmitter for a position generator and sends a magnetic field radially in the direction of a sensor element 36, preferably in the shape of a Hall sensor, a magneto-resistive sensor or a Reed contact, that is fixed to the housing 6 and is connectable to an electronic control unit (not shown) in order to enable position detection. It should be taken into consideration that a Hall sensor or a magneto-resistive sensor as an active component also requires a current supply, while a Reed contact as a controlled switch is only active as a break contact or make contact of an electric circuit. For the purpose of a better linking within a bus system, the sensor element 36 can also be provided with local intelligence in the form of a so-called ASIC (Application Specific Integrated Circuit).

The magnet 35 is annular and, as is apparent, arranged between plates 37, 38 made of a magnetic material on a cylindrical bead member 39 made of a non-magnetic material which has a collar 40 for the axial abutment of the magnet 35. Support member 39 is displaceable within limits on the peg-shaped piston portion 34 and, for the limitation of the displacement travel of the magnet 35, is furnished with an end stop 41 which can be designed like the stop 30, 31 described hereinabove. As can be seen from FIG. 1, the support member 39 with the magnet 35 is acted upon by the resetting spring 14 of the first piston 2, on the one hand, and, on the other hand, by another spring means 42 which is supported on the second piston 3 so that the magnet 35 is quasi compressed between the pistons 2, 3 and displaceable in relation to these. The spring force of the resetting spring 14 is, however, in excess of the spring force of the additional spring means 42. This renders possible displacement of the magnet 35 induced by actuation, even if the second piston 3 is undisplaceably fixed due to a driving dynamics control operation.

In contrast to the resetting springs 14, 15, the additional spring means 42 is obviously a conical helical spring.

The embodiment of FIG. 1 is advantageous in that the support member 39 for the magnet 35, in the event of leakage in the area of the second piston 3 (secondary brake circuit), is additionally used for the support of the first piston 2 (push rod piston) because the support member 39 moves into abutment on the piston 3 after the spring means 42 has been compressed.

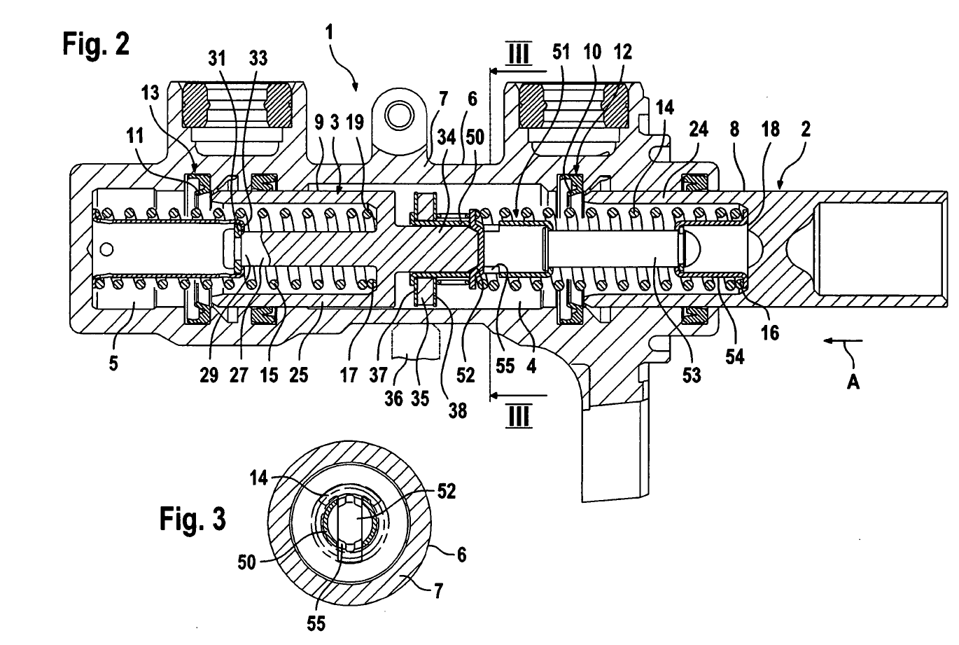

The embodiment of FIG. 2 largely corresponds to the embodiment of FIG. 1 so that equal features have been designated by equal reference numerals, and there is no need to repeat related parts of the description. Therefore, exclusively basic differences will be dealt with in the following.

The support member 50 for the magnet 35 is designed as a non-magnetic sleeve which is a component part of a cage 51 for the resetting spring 14. Cage 51 includes a sleeve, a spring accommodation 52, a push rod 53, and another sleeve 54. The two sleeves (support member 50, 54) and the push rod 53 can be telescoped within limits by means of mutual stops and, according to this embodiment, bring about an elastic preload of the resetting spring 14 in the non-actuated condition. The spring accommodation 52 is displaceable in an axial direction in relation to the sleeve (support member 50) within a recess 55 and is supported on a front side of the peg-shaped piston portion 34, with the result that also the resetting spring 14 is supported on the peg 34. When the resetting spring 14 is compressed due to actuation, displacement of the push rod 53 permits an expansion of the additional spring means 42 which is configured as a cylindrical helical spring in this embodiment. This provision allows displacement of the magnet 35 into the area of the sensor element 36. In the event of pressure loss (leakage) in the secondary circuit of the piston 3, a central direct support of the piston 2 (push rod piston) on the piston 3 (secondary piston) takes place by way of the push rod 53.

FIG. 3 illustrates in a cross-section in particular the described components, i.e. sleeve (support member 50), spring accommodation 52, resetting spring 14, and housing 6.

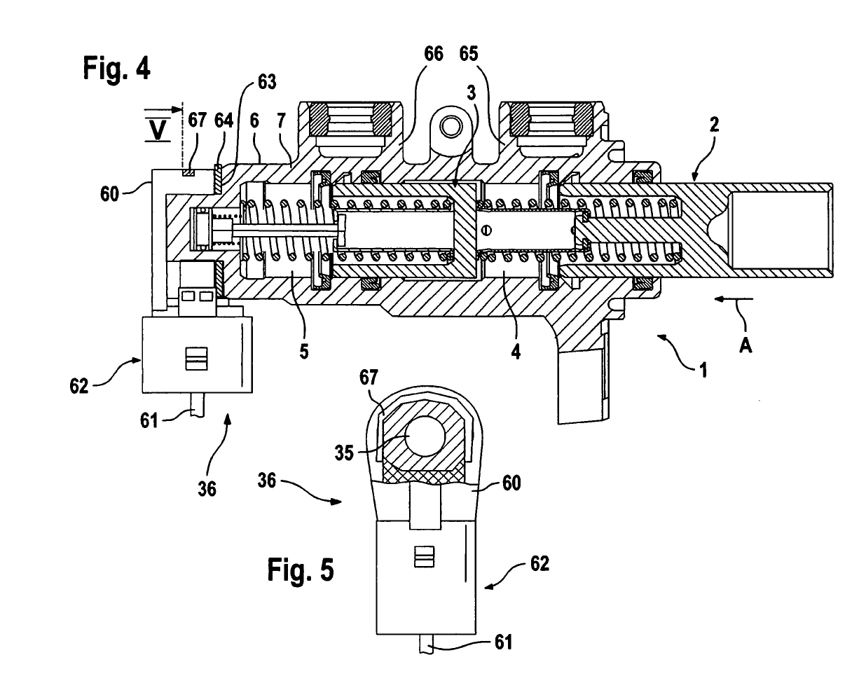

To allow exchangeability and adjustability of a sensor element 36, said element is arranged in an accommodation 60 that can be fixed in a defined position at the housing 6 according to FIGS. 4 and 5. The sensor element 36 is then form-lockingly accommodated as an exchangeable structural unit together with rigid conductor elements in the accommodation 60. An electric connecting line 61 which can be slipped with a plug device 62 into the accommodation 60 is used for the electrical connection with an electronic control unit of the brake system or any other control unit at the vehicle end which is linked to the brake system.

If adjustability of the accommodation 60 is not required, said accommodation can be screwed to a base of the housing 6, and defined walls or contact areas can be provided at the base for abutment of the accommodation 60. It is advisable in this respect when the accommodation 60 includes a housing made of plastic material, the outside wall of said having contact lugs in the area of contact surfaces at the base end, said contact lugs deforming during mounting the accommodation at the housing 6 by a tight abutment on the contact surfaces in such a fashion that a clearance-free attachment of the accommodation is achieved.

In another variation, the adjustability is ensured because the accommodation 60 is adjustable in an actuating direction of a piston 2, 3 and in relation to the housing 6 and is fixable in a defined position. According to FIG. 4, the housing 6 has a stop 63 for the accommodation 60, and at least one precisely tolerated spacer element 64 is arranged between stop 63 and accommodation 60 for safeguarding a defined relative position between sensor element 36 and pistons 2, 3. Principally, the accommodation 60 for monitoring the position of a push rod piston (piston 2) can be arranged in a space-saving fashion between two pressure fluid reservoir ports 65, 66. According to FIG. 4, however, the accommodation is provided at a housing end, which safeguards ease of access to the device. A separate clip 67 between accommodation 60 and sensor element 36 is used as a form-locking safety element against detachment.

FIG. 5 illustrates the sensor element including accommodation 60 in a schematic top view.

The movement and actuation of magnet 35 takes place in the embodiments according to FIGS. 2 to 5 in parallel to the movements of the two pistons 2, 3.

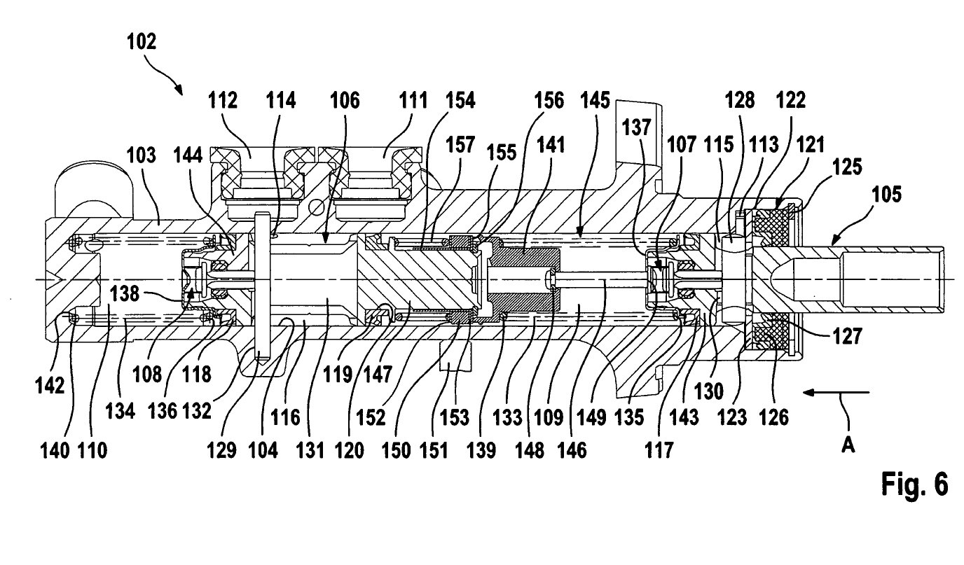

The master cylinder of FIGS. 6 to 19 is configured as a so-called central-valve tandem master cylinder 102. Said cylinder includes in its basic design a housing 103 with a longitudinal bore 104 for a first piston (push rod piston) 105 and a second piston (floating piston) 106. Further, there is provision of one central valve 107, 108 for each piston 105, 106. The respective central valve 107, 108 interacts for sealing an associated pressure chamber 109, 110 with the respective piston 105, 106 in consideration of a predetermined closure travel.

From a supply reservoir (not shown), supply channels 113, 114 open by way of connections 111, 112 into respective supply chambers 115, 116 which are sealed in relation to the associated pressure chambers 109, 110 by means of primary sealing cups 117, 118. Further, the supply chamber 116 is sealed by means of a secondary sealing cup 119 in relation to the first pressure chamber 109, and the secondary sealing cup 119 is arranged in a circumferential groove 120 of the second piston 106.

A sealing assembly 121 arranged in a recess 122 seals the supply chamber 115 relative to the atmosphere. The sealing assembly 121 is limited by a plate 123 on the side facing the pressure chamber 109, and a safety element 125 secures the sealing assembly 121 and the plate 123 in the recess 122.

The sealing assembly 121 has a guide ring 126 which is made of a plastic material and serves as a low-wear guide of the first piston 105, and a secondary sealing cup 127 arranged on the guide ring 126 in the direction of the first pressure chamber 109.

In a non-actuated condition, the central valves 107, 108 are kept open by stops 128, 129 designed as cylindrical pins, with the stops 128, 129 extending through slit-shaped recesses 130, 131 of the pistons 105, 106. The stop 128 is arranged in the longitudinal bore 104, and it abuts on the plate 123. On the other hand, the stop 129 is fixed in a housing bore 132 of the housing 103, and the slit-shaped recess 131 of the second piston 106 is arranged in an area between the primary cup seal 118 and the secondary cup seal 119.

Associated with each of the pistons 105, 106 is a resetting spring 133, 134 which is supported with a first end 135, 136 on a first sleeve 138, 138 and with a second end 139, 140 on a second sleeve 141 or on a housing bottom 142, respectively. The first sleeve 137, 138 of the resetting spring 133, 134 is supported on a first piston portion 143, 144 or the first or the second piston 105, 106, respectively. Upon piston displacement in an actuating direction A, the resetting spring 133, 134 is compressed, while it is expanded for piston resetting purposes.

The mode of functioning of the central-valve tandem master cylinder 102 is principally known in the art. The first piston 105 is displaced to the left in the actuating direction A when a brake pedal (not shown) is applied. This linear movement of the first piston 105 causes the associated central valve 107 to close so that the corresponding pressure chamber 109 is shut off in relation to its connection 11 through the supply channel 113 and the supply chamber 115 to the supply reservoir (not shown). In consequence of the developing hydrostatic pressure in the pressure chamber 109, the second piston 106 is moved synchronously with the first piston 105 in the actuating direction A and closes its central valve 108 in the associated brake circuit. Hydraulic pressure will now equally develop in this brake circuit because the pressure chamber 110 is here closed in relation to its connection 112 through the supply channel 114 and the supply chamber 116 to the supply reservoir. Consequently, practically the same hydraulic pressure prevails in both pressure chambers 109, 110 and is transmitted to wheel brakes (not shown).

In the following, the embodiment according to FIG. 6 will be referred to in detail, showing a longitudinal cross-sectional view of the central-valve tandem master cylinder 102.

The resetting spring 133 of the first piston 105 is retained in a cage 145 which includes the first sleeve 137, the second sleeve 141, and a push rod 146 as component parts. The two sleeves 137, 141 and the push rod 146 can be telescoped within limits by means of stops 148, 149 provided on the push rod 146 and, in the non-actuated condition, bring about an elastic preload of the resetting spring 133.

The second piston 106 includes a second, peg-shaped piston portion 147 and, thus, the second piston 106 has an extended design in contrast to the prior-art pistons, this extension serving as a means to guide a permanent magnet 150. The permanent magnet 150, in turn, is used as a signal transmitter for a position generator and sends a magnetic field radially in the direction of a sensor element 151, preferably in the shape of a Hall sensor, a magneto-resistive sensor or a Reed contact, which is fixed to the housing 103, and is connectable to an electronic control unit (not shown) in order to enable position detection. It should be taken into consideration that a Hall sensor or a magneto-resistive sensor as an active component also requires a current supply, while a Reed contact as a controlled switch is only active as a break contact or make contact of an electric circuit. For the purpose of a better linking within a bus system, the sensor element 155 can also be provided with local intelligence in the form of a so-called ASIC (Application Specific Integrated Circuit).

The magnet 150 is annular and, as apparent, is arranged between plates 152, 153 made of a magnetic material on a cylindrical support member 154 made of a non-magnetic material which has a bead 155 for the axial abutment of the magnet 150. Support member 154 is displaceable within limits on the second piston portion 147 and, for the limitation of the displacement travel of the support member 154 and hence the magnet 150, is furnished with an end stop 156.

The annular shape of the magnet 150 renders it possible to attach the sensor element 151 not only in one position like illustrated in FIG. 6, but in any desired position along the periphery of the housing 103.

As can be seen in FIG. 6, the support member 154 with the magnet 150 is acted upon by means of the second sleeve 141 by the resetting spring 133 of the first piston 105, on the one hand, and, on the other hand, by another spring means 157 which is supported on the second piston 106 so that the magnet 150 is quasi compressed between the pistons 105, 106 and is displaceable in relation to these. The spring force of the resetting spring 133 is, however, in excess of the spring force of the additional spring means 157. This renders possible displacement of the magnet 150 induced by actuation, even if the second piston 106 is undisplaceably fixed due to a driving dynamics control operation, because the movement of the second sleeve 141, which is supported on the bead 155 of the support member 154, triggers the movement of the magnet 150 and of the pole plates 152, 153.

Like the embodiment according to FIG. 1, this embodiment is advantageous in that the support member 154 for the magnet 150, in the event of leakage in the area of the second piston 106 (secondary brake circuit), additionally serves to support the first piston 105 because the support member 154 moves into abutment on the piston 106 after compression of the spring means 157.

The movement and actuation of the magnet 150 occur in this embodiment like in the embodiment of FIG. 1 in series with respect to the movements of the two pistons 105, 106.

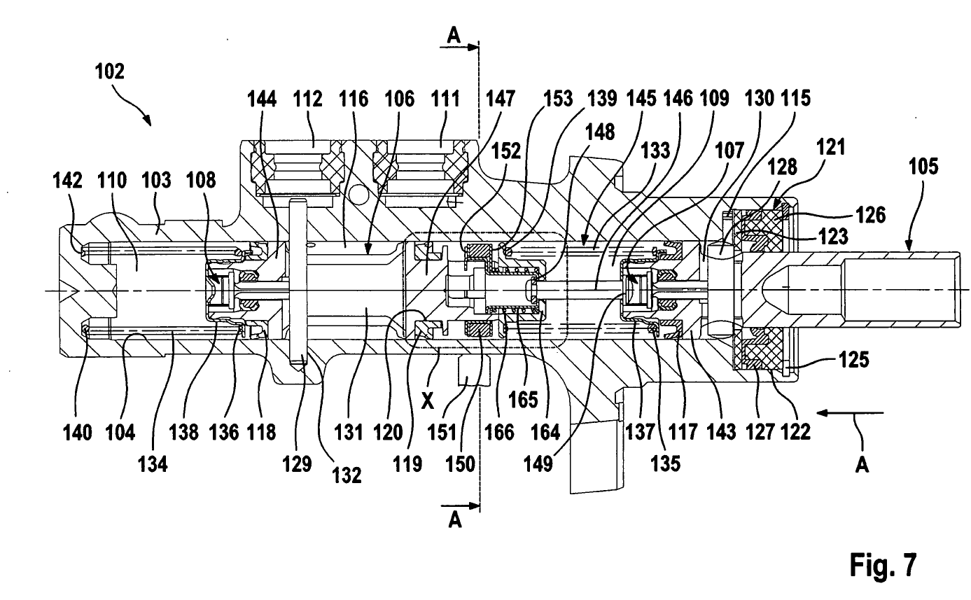

The embodiments according to FIGS. 7 to 19 as described in the following allow a design which is optimized especially in terms of mounting space because the movement and the actuation of the magnet 150 take place in parallel to the movements of the two pistons 105, 106.

With the exception of the movement and actuation of the magnet, the embodiments according to FIGS. 7 to 19 correspond largely with the embodiment according to FIG. 6 so that equal features have been designated by equal reference numerals and it has been omitted to repeat related parts of the description. Therefore, exclusively the basic differences will be dealt with in the following.

In contrast to the embodiment of FIG. 6, in the embodiments according to FIGS. 7 to 10 the cage 145, in which the resetting spring 133 of the first piston 105 is retained, comprises the first and a second sleeve 137, 164, the push rod 146, a non-magnetic sleeve-shaped support member 165, and an additional spring means 166 whose spring force is lower than that of the resetting spring 133.

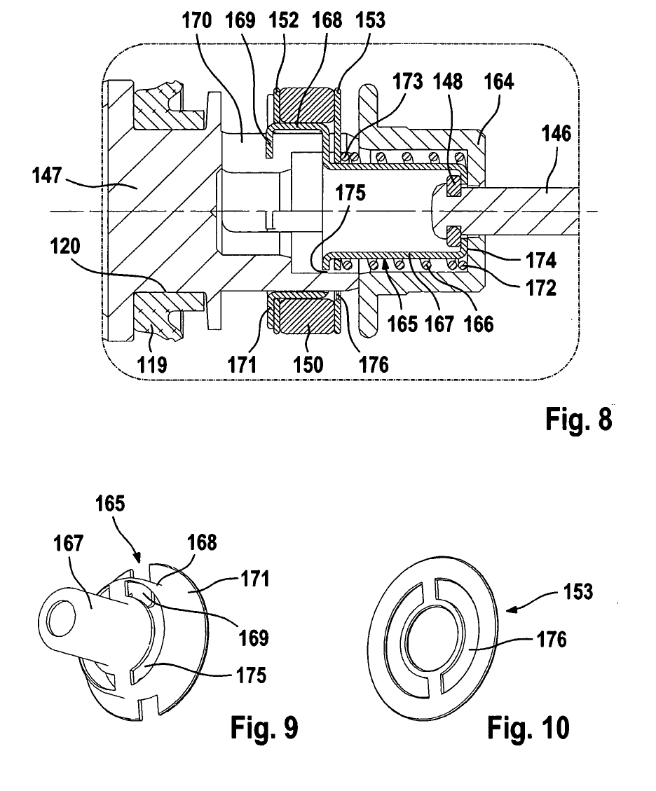

FIG. 8 shows an enlarged view of the cut-out X of FIG. 7. It can be seen that the support member 165, which can e.g. be manufactured from a thin sheet-metal material by means of a forming process, is interposed between the stop 148 of the push rod 146 and the second sleeve 164. As the resetting spring 133 abuts with its end 139 on the second sleeve 164, the support member 165 is maintained in abutment on the stop 148 caused by the preload of the second sleeve 164 by means of the resetting spring 133 in the actuating direction A. The second sleeve 164 bears against the piston portion 147 of the second piston 106, as can be taken from FIGS. 7 and 8.

The support member 165 which is shown individually in FIG. 9 includes a first cylindrical portion 167 and a second cylindrical portion 168, and the second portion 168 has a larger diameter than the first portion 167. The permanent magnet 150 and the plate 152 are arranged on the second cylindrical portion 168 of the support member 165.

It can be seen from FIG. 7 in particular that the support member 165 with its second cylindrical portion 168 is guided on the second piston portion 147 of the second piston 106, and inwards pointing radial projections 169 engage into recesses 170 of the second piston portion 147 as a guide and rotation-prevention mechanism of the support member 165. This means, the permanent magnet 150 in this arrangement is not guided directly on the second piston portion 147 of the second piston 106, but indirectly due to the support member 165.

A radially outwards pointing bead 171 of the second portion 168 is used for the abutment of the plate 152 and the magnet 150. The additional spring means 166 which is arranged in a radial direction between the second sleeve 164 and the support member 165 abuts with its first end 172 on an inside surface 174 of the second sleeve 164 and with its second end 173 on the plate 153, whereby the support member 165, the magnet 150 and the plates 152, 153 are biased and retained in the position shown in FIGS. 7 and 8.

It becomes apparent from FIG. 8 that the second piston portion 147 extends through recesses 175 of the support member 165 and recesses 176 of the plate 153, which is shown in FIG. 10, and thus bears against the second sleeve 164.

When the second piston 106 is undisplaceably fixed in position due to a driving dynamics control operation, the displacement of the push rod 146 in the actuating direction A during an actuation-induced compression of the resetting spring 133 allows an expansion of the additional spring means 166. The support member 165 is thereby displaced along with the magnet 150 and the two plates 152, 153 in the actuating direction A into the area of the sensor element 151.

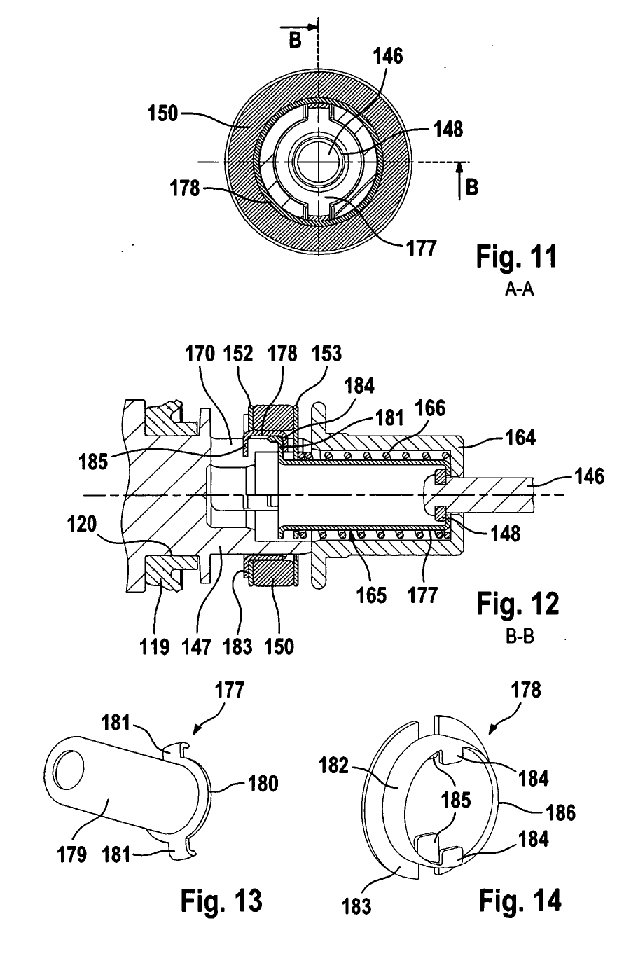

The embodiment according to FIGS. 11 to 14 differs from the above-described embodiment according to FIGS. 7 to 10 only in the configuration of the support member 165, which has a bipartite designed composed of a spring sleeve 177 and a magnet sleeve 178 in the embodiment that will be described hereinbelow. This obviates the need for a total view of a central-valve tandem master cylinder 102 in the longitudinal cross-section for this embodiment.

FIG. 11 shows a cross-section through the central-valve tandem master cylinder 102 taken along a line A-A which is indicated in FIG. 7 of the above-mentioned embodiment.

It can be seen from FIG. 12, which shows a cross-section taken along line B-B through FIG. 11, that the support member 165 of this embodiment comprises the two components spring sleeve 177 and magnet sleeve 178, however, in other respects bears against the stop 148 of push rod 146, as described with regard to FIGS. 7 and 8, and is secured in the position shown by means of the resetting spring 133 or the preloading force of the resetting spring on the second sleeve 164, respectively. The embodiment can be clearly seen in FIGS. 13 and 14 showing the spring sleeve 177 or the magnet sleeve 178, respectively.

It becomes apparent from FIG. 13 in particular that the spring sleeve 177 has a cylindrical portion 179 and a circumferential radially outwards directed bead 180. Projecting from the bead 180 are two radial projections 181 which are used for the connection with the magnet sleeve 178, on the one hand, and as a guide and rotation-prevention mechanism of the spring sleeve 177 in the recesses 170 of the second piston portion 147, on the other hand.

FIG. 14 illustrates that the magnet sleeve 178 also includes a cylindrical portion 182 and a radially outwards directed bead 183. Further, there is provision of radially inwards directed projections 184, 185 which are used for the connection with the spring sleeve 177, on the one hand, and as a guide and rotation-prevention mechanism of the magnet sleeve 178 in the recesses 170 of the second piston portion 147, on the other hand. The projections 184 are arranged at an edge 186 of the cylindrical portion 182. The projections 185 can e.g. be shaped by forming measures of the bead 183.

As can be seen from FIG. 12, the magnet 150 is arranged on the cylindrical portion 182 of the magnet sleeve 178 and the plate 152 abuts under the preload of the additional spring means 166 on the bead 183 of the magnet sleeve 178. The projections 181 of the spring sleeve 177 are interposed between the projections 184 and 185 of the magnet sleeve 178 in the assembled condition of the support member 165. As the projections 181, 184, 185 are guided in the recesses 170, the two components 177, 178 cannot rotate in relation to one another, whereby the connection of the two components 177, 178 is safeguarded.

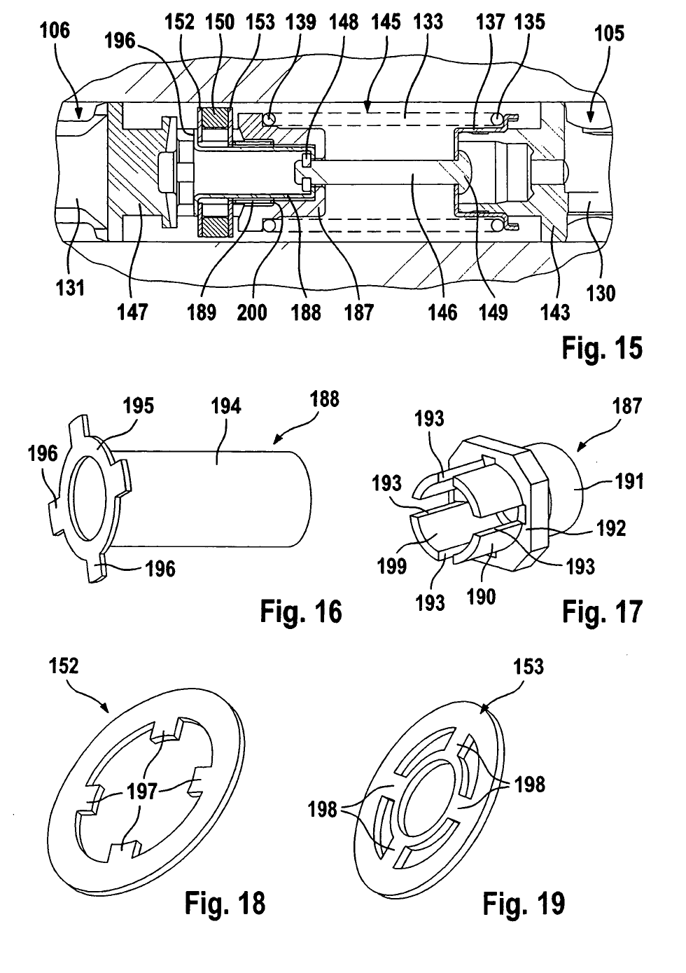

FIGS. 15 to 19 show another embodiment of the central-valve tandem master cylinder 102.

The cage 145 in which the resetting spring 133 of the first piston 105 is retained comprises herein the first and a second sleeve 137, 138, the push rod 146, a non-magnetic sleeve-shaped support member 188, and an additional spring means 189 whose spring force is lower than that of the resetting spring 133.

As becomes obvious from FIG. 15 which shows a cut-out of a central-valve tandem master cylinder 102, the magnet 150 and the plates 152, 153 are guided and arranged on the second sleeve 187. To this end, the second sleeve 187, as FIG. 17 shows in particular, includes a first and a second cylindrical portion 190, 191 and a circumferential bead 192 interposed between them. The first cylindrical portion 190 is furnished with slit-shaped axial recesses 193, and the magnet 150 is guided on the first cylindrical portion 190, and the recesses 193 are used to guide the support member 188 and the plates 152, 153.

It is apparent from FIG. 16 that the support member 188 has a design similar to that of the spring sleeve 177 according to FIG. 16 and includes a cylindrical portion 194 and a circumferential, radially outwards directed bead 195. Projecting from the bead 195 are radial projections 196 which are used as a guide and rotation-prevention mechanism of the support member 188 in the recesses 193 of the second sleeve 187 and as an abutment of the plate 152. To this end, the plate 152 which is shown in FIG. 18 has radially inwards directed projections 197.

Likewise, plate 153, which is shown in FIG. 19, includes radial webs 198 which are used as a guide and rotation-prevention mechanism of the plate 153 in the recesses 193 of the second sleeve 187.

FIG. 15 shows that the support member 188 abuts on the stop 148 of the push rod 146 and is arranged between the stop 148 and the second sleeve 187. The second sleeve 187 abuts on the second piston portion 147, and the bead 192 of the second sleeve 187 is used for the abutment of the end 139 of the resetting spring 133 and, hence, for the preload thereof. This provision also maintains the support member 188 in the position shown.

The additional spring means 189 is retained in a biased manner between the plate 153 and a step 200 disposed on an inside surface 199 of the second sleeve 187.

When the second piston 106 is undisplaceably fixed in position due to a driving dynamics control operation, the displacement of the push rod 146 in the actuating direction A allows during an actuation-induced compression of the resetting spring 133. The additional spring means 189 is expanded because the second sleeve 187 abuts on the second piston 106 and is not displaced along with the push rod 146. The support member 188 is thereby displaced along with the magnet 150 and the two plates 152, 153 in the actuating direction A into the area of the sensor element 151.

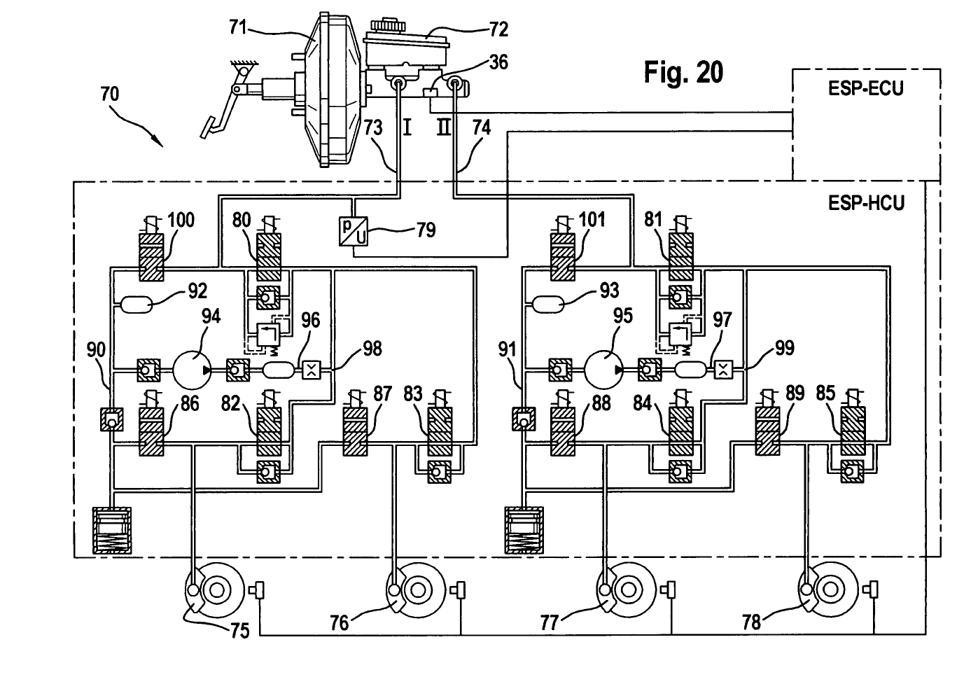

FIG. 20 serves to explain a brake system 70 with a driving dynamics control (ESP), where the invention can be implemented in particular. The brake system 70 comprises a brake device with a pneumatic brake booster 71, the master cylinder 1 or 102 with a pressure fluid supply reservoir 72, and pressure chambers of the master cylinder 1, 102 are connected to the wheel brakes 75-78 by way of brake lines 73, 74. Wheel brakes 75-78 are combined in pairs in so-called brake circuits I, II. Regarding the brake circuits I, II, the so-called diagonal circuit allotment grouping diagonally opposite wheel brakes of the front axle and the rear axle of a vehicle has become generally accepted, while principally a different circuit allotment such as the so-called black/while allotment is also possible, combining the wheel brakes of one axle in a pair.

A pressure sensor 79 at the brake line 73 is used to sense a pressure introduced by the driver, the brake line connecting a pressure chamber to the wheel brakes 75, 76 of brake circuit I. Each brake line 73, 74 includes in a serial arrangement electromagnetic separating valves 80, 81 and each one inlet valve 82-85 and each one outlet valve 86-89 for each wheel brake 75-78. The two wheel brakes 75, 76; 77, 78 of each one brake circuit I, II are connected to a return line 90, 91, with the outlet valve 86-89 being respectively inserted into the line branches per wheel brake 75-78. Connected downstream of the outlet valves 86-89 in each return line 90, 91 is a low-pressure accumulator 92, 93 that is connected to an inlet of an electromotively driven pressure fluid supply device 94, 95 feeding the two brake circuits I, II. There is a hydraulic connection between an outlet of each pressure fluid supply device 94, 95 and the associated brake circuit I, II by way of pressure channel 96, 97 and a branch line 98, 99, and the pressure increase in the wheel brakes 75-78 is controllable by way of the inlet valves 82-85. This renders it possible to introduce pressure into the wheel brakes 75-78 by way of the pressure fluid supply devices 94, 95 for driving stability intervention purposes or for braking operations, without having to make use of a central high-pressure accumulator such as in electrohydraulic brake systems.

In order to allow changing between ABS return delivery operations (supply direction in the direction of the master brake cylinder) and TCS or ESP driving dynamics control operations (supply direction in the direction of the wheel brakes) by means of the pressure fluid supply devices 94, 95, one change-over valve 100, 101 is respectively integrated in the aspiration branch of each pressure fluid supply device 94, 95, said valve being able to establish a pressure fluid connection between the master cylinder 1 and the inlet of the pressure fluid supply devices 94, 95 in the event of active driving dynamics control.

### LIST OF REFERENCE NUMERALS

1 master cylinder
2 piston
3 piston
4 pressure chamber
5 pressure chamber
6 housing
7 housing wall
8 piston wall
9 piston wall
10 sealing lip
11 sealing lip
12 sealing cup
13 sealing cup
14 resetting spring
15 resetting spring
16 end
17 end
18 piston bottom
19 piston bottom
20 collar
21 collar
22 sleeve
23 sleeve
24 wall
25 wall
26 peg
27 peg
28 end
29 end
30 stop
31 stop
32 collar
33 collar
34 piston portion
35 magnet
36 sensor element
37 plate
38 plate
39 support member
40 bead
41 stop
42 spring means
50 support member
51 cage
52 spring accommodation
53 push rod
54 sleeve
55 recess
60 accommodation
61 connecting line
62 plug device
63 stop
64 spacer element
65 pressure fluid reservoir port
66 pressure fluid reservoir port
67 clip
70 brake system
71 brake booster
72 pressure fluid supply reservoir
73 brake line
74 brake line
75 wheel brake
76 wheel brake
77 wheel brake
78 wheel brake
79 pressure sensor
80 separating valve
81 separating valve
82 inlet valve
83 inlet valve
84 inlet valve
85 inlet valve
86 outlet valve
87 outlet valve
88 outlet valve
89 outlet valve
90 return line
91 return line
92 low-pressure accumulator
93 low-pressure accumulator
94 pressure fluid supply device
95 pressure fluid supply device
96 pressure channel
97 pressure channel
98 branch line
99 branch line
100 change-over valve
101 change-over valve
102 master cylinder
103 housing
104 longitudinal bore
105 piston
106 piston
107 central valve
108 central valve
109 pressure chamber
110 pressure chamber
111 connection
112 connection
113 supply channel
114 supply channel
115 supply chamber
116 supply chamber
117 primary cup seal
118 primary cup seal
119 secondary cup seal
120 groove
121 sealing assembly
122 recess
123 plate
125 safety element
126 guide ring
127 secondary cup seal
128 stop
129 stop
130 recess
131 recess
132 housing bore
133 resetting spring
134 resetting spring
135 end
136 end
137 sleeve
138 sleeve
139 end
140 end
141 sleeve
142 housing bottom
143 piston portion
144 piston portion
145 cage
146 push rod
147 piston portion
148 stop
149 stop
150 magnet
151 sensor element
152 plate
153 plate
154 support member
155 bead
156 stop
157 spring means
164 sleeve
165 support member
166 spring element
167 portion
168 portion
169 projection
170 recess
171 bead
172 end
173 end
174 inside surface
175 recess
176 recess
177 spring sleeve
178 magnet sleeve
179 portion
180 bead
181 projection
182 portion
183 bead
184 projection
185 projection
186 edge
187 sleeve
188 support member
189 spring means
190 portion
191 portion
192 bead
193 recess
194 portion
195 bead
196 projection
197 projection
198 web
199 inside surface
200 step
A actuating direction

1-26. (canceled)

27. A device for monitoring the position and movement of a brake pedal, the device comprising:
a master cylinder (1; 102) with an integrated position generator for monitoring the position of a displaceable piston (2, 3; 105, 106) within a housing, the position generator includes a magnet (35; 150) as a signal transmitter which transmits a magnetic field in the direction of a sensor element (36; 151) being stationary on the housing (6, 103), and is connectable to an electronic control unit; wherein the magnet (35; 150) is arranged between two pistons (2, 3; 105, 106) and is displaceable in relation to at least one of the pistons (2, 3; 105, 106).

28. The device according to claim 27 wherein, at least two spring members are provided, by way of which the magnet (35; 150) is retained between the pistons (2, 3; 105, 106) and is arranged so as to be displaceable in relation to at least one of the pistons (2, 3; 105, 106).

29. The device according to claim 28, wherein the spring members comprise a resetting spring (14; 133) supported on the first piston (2; 105) and an additional spring member (42; 157; 166; 189) supported on the magnet (35; 150), with the additional spring member (42; 157; 166; 189) showing a higher degree of resiliency than the resetting spring (14; 133).

30. The device according to claim 29, wherein the sensor element (36; 151) comprises at least one Hall sensor.

31. The device according to claim 30, wherein the piston (3; 106) includes a device for guiding the magnet (35; 150).

32. The device according to claim 31, wherein the piston (3; 106) has a peg-shaped piston portion (34; 147) to guide the magnet (35; 150).

33. The device according to claim 32, wherein a support member (39; 50; 154; 165) made of a non-magnetic material is arranged between the magnet (35; 150) and the piston portion (34; 147), and in that the magnet (35; 150) is interposed in an axial direction between plates (37, 38; 152, 153) made of an iron material.

34. The device according to claim 33, wherein the support member (39; 50; 154; 165) has a one-part and substantially cylindrical design.

35. The device according to claim 34, wherein the support member (39; 154) has a bead (40; 155) for the axial abutment of the magnet (35; 150), and a stop (41; 156) is provided at the piston portion (34, 147) for limiting the relative displacement travel of the support member (39; 154) with respect to the piston (3; 106), with the additional spring member (42; 157) being supported on the piston (3; 106).

36. The device according to claim 35, wherein a resetting spring (14) is arranged at least partly within a bowl-shaped wall (24) of the piston (2) and is centrally penetrated by a peg (26) with a stop (30) on which a sleeve (22) is fixed in position in such a fashion that, upon displacement of the piston (2) during actuation, the device for guiding the magnet (35) plunges axially and telescopically into the interior of the sleeve (22).

37. The device according to claim 34, wherein the support member (165) includes a first cylindrical portion (167) and a second cylindrical portion (168), and the magnet (150) is arranged on the second cylindrical portion (168) of the support member (165), while the support member (165) with its second cylindrical portion (168) is guided on the piston portion (147) of the second piston (106).

38. The device according to claim 37, wherein the support member (165) has projections (169) which point radially inwards and, as a guide and rotation-prevention mechanism of the support member (165), engage into recesses (170) of the second piston portion (147).

39. The device according to claim 33, wherein the support member (165) has a multi-part design and includes a spring sleeve (177) and a magnet sleeve (178), and the spring sleeve (177) includes radially outwards pointing projections (181) being arranged between radially inwards pointing projections (184, 185) of the magnet sleeve (178) for the connection with the magnet sleeve (178), with said projections (181, 184, 185), as a guide and a rotation-prevention mechanism of the support member (165) on the piston portion (147), engaging into recesses (170) of the second piston portion (147), and with the magnet (150) being arranged on the magnet sleeve (178).

40. The device according to claim 39, wherein the resetting spring (14; 133) and the additional spring member (42; 166; 189) are joined in an elastically biased manner by means of a cage (51; 145) in such a fashion that displacement of the piston (2; 105) during actuation allows compression of the resetting spring (14; 133) and expansion of the additional spring member (42; 166; 189) in order to render possible a proportional relative displacement of the magnet (35; 150) in relation to the piston (2; 105).

41. The device according to claim 40, wherein the cage (51) includes a sleeve for the mounting support of the magnet (35) and a spring accommodation (52) which is arranged thereon so as to be displaceable within limits and is acted upon by resetting spring (14) and spring member (42), which spring accommodation, when the piston (2) is displaced during actuation, is movable into abutment on the piston (3) in such a fashion that sleeve and magnet (35) are displaced in the actuating direction (A) in relation to the piston (3) by way of expansion of the spring member (42).

42. The device according to claim 40, wherein the cage (145) has a first sleeve (137) and a second sleeve (164; 187) for preloading the resetting spring (133) and a support member (165; 188), wherein upon displacement of the piston (105) during actuation the magnet (150) is displaced in relation to the piston (106) in the actuating direction (A) by way of expansion of the additional spring member (166; 189).

43. The device according to claim 42, wherein the magnet (150) is guided and arranged on the second sleeve (187), and the support member (188) has projections (196) pointing radially outwards and being guided in recesses (193) of the second sleeve (187).

44. The device according to claim 43, wherein the magnet (150) is interposed in an axial direction between plates (152, 153) made of an iron material which include radially inwards pointing projections (197) and webs (198) that are guided in the recesses (193) of the second sleeve (187).

45. The device according to claim 44, wherein the second sleeve (187) has a step (200) on an inside surface (199), and the additional spring member (189) is arranged between the step (200) and the plate (153) in a biased manner.

46. The device according to claim 45, wherein an additional spring member is interposed in a biased manner between the first sleeve and the support member.

47. The device according to claim 27, wherein the sensor element (36; 151) is arranged in an accommodation (60) that can be fixed in a defined position on the housing (6; 103).

48. The device according to claim 47, wherein the sensor element (36; 151) along with rigid conductor elements is received in the accommodation (60) in a form-locking manner, and in that an electric connecting line (61) can be slipped into a plug device (62) of the accommodation (60).

49. The device according to claim 48, wherein the accommodation (60) is adjustable in the actuating direction (A) of the piston (2, 3; 105, 106) and in relation to the housing (6; 103) and can be fixed in a defined position.

50. The device according to claim 49, wherein the housing (6; 103) has a stop (63) for the accommodation (60), and in that at least one spacer element (64) is arranged between stop (63) and accommodation (60) for providing a defined positioning of the sensor element (36).

51. The device according to claim 49, wherein the accommodation (60) is arranged between two pressure fluid reservoir ports (65, 66).

52. The device as claimed in claim 49, wherein the accommodation (60) is arranged at a housing end.
